(19) United States
(12) Patent Application Publication
(10) Pub. No.: US 2007/0216756 A1
(43) Pub. Date: Sep. 20, 2007

(54) Laser beam scanning apparatus, image forming apparatus, and laser beam scanning method

(75) Inventors: Kenichi Komiya, Kanagawa-ken (JP); Koji Tanimoto, Shizuoka-ken (JP); Daisuke Ishikawa, Shizuoka-ken (JP); Yuji Inagawa, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/376,776

(22) Filed: Mar. 15, 2006

(51) Int. Cl. B41J 2/435

(52) U.S. Cl. 347/246

(57) ABSTRACT

A laser beam scanning apparatus includes: a laser oscillating unit that outputs a laser beam; a laser beam scanning unit that scans and irradiates the laser beam in a main scanning direction on a photosensitive member; an error signal generating unit that monitors intensity of a laser beam and generates an error signal between output intensity of the laser oscillating unit and a reference value; a correction signal generating unit that generates a correction signal for correcting intensity of a laser beam along the main scanning direction to be constant; a correction signal converting unit that converts a correction signal into an adapted correction signal by attenuating the correction signal; and a laser control signal generating unit that holds, during the image formation period, a reference signal generated on the basis of the error signal and applies the adapted correction signal to the reference signal to generate a laser control signal for determining intensity of a laser beam outputted from the laser oscillating unit.

### BACKGROUND OF THE INVENTION

1. Field of the Invention

The present invention relates to a laser beam scanning apparatus, an image forming apparatus, and a laser beam scanning method, and, more particularly to a laser beam scanning apparatus that scans a photosensitive drum included in an image forming apparatus such as a laser printer or a digital copying machine with a laser beam to form an electrostatic latent image, an image forming apparatus having the laser beam scanning apparatus, and a laser beam scanning method.

2. Description of the Related Art

In recent years, various image forming apparatuses such as a digital copying machine and a laser printer that perform image formation according to scanning exposure by a laser beam and an electrophotographic process have been developed.

These image forming apparatuses include a laser beam scanning apparatus that scans a photosensitive drum with a laser beam to form an electrostatic latent image on the photosensitive drum. The laser beam scanning apparatus includes a laser oscillator that generates a laser beam, a polygon mirror that reflects the laser beam outputted from the laser oscillator to the photosensitive drum to cause the laser beam to scan the photosensitive drum, and an f-θ lens.

Toner development is applied to the electrostatic latent image formed on the photosensitive drum. A toner developed image is finally transferred onto recording paper as a recorded image. Therefore, in order to form a uniform recorded image without unevenness, it is necessary to form an electrostatic latent image having uniform intensity on the photosensitive drum. It is important to stabilize intensity of the laser beam. In general, the laser oscillator used in the laser beam scanning apparatus has an APC (Auto Power Control) function.

Laser oscillation intensity is monitored by a photo-detector that is built in the laser oscillating unit or disposed near the laser oscillating unit. The laser oscillator is controlled to have a fixed output. According to the APC function, an output of the laser oscillator is corrected such that a fixed output value is always obtained regardless of an individual difference of an output characteristic of an individual laser oscillator.

A Patent Document (JP 9-216414A) and the like disclose a technique for arranging a photo-detector near a photosensitive drum in order to correct not only the individual difference of a laser oscillator but also an individual difference of a loss on a path leading from the laser oscillator to a photosensitive drum.

However, even if an output of the laser oscillator is fixed, intensity of a laser beam irradiated on a photosensitive member (the photosensitive drum) is not always constant. This is mainly because a transmission loss of the f-θ lens varies depending on an angle of incidence. In general, an angle of incidence of a laser beam to the f-θ lens is substantially vertical in the center of the f-θ lens. The laser beam is made incident obliquely at a larger angle in positions closer to the ends of the f-θ lens. As a result, a transmission loss of the f-θ lens is the smallest in the center and is larger in positions closer to the ends of the f-θ lens.

This means that, from the viewpoint of intensity of a laser beam irradiated on the photosensitive drum, the intensity is the largest in the center of the f-θ lens and is smaller in positions closer to the ends of the f-θ lens to be non-uniform with respect to a main scanning direction.

Conventionally, as a method of correcting such non-uniformity in the main scanning direction, a method of contriving thickness and types of a coating layer of the f-θ lens to optically uniformalize a transmission loss is adopted. Consequently, machining of the f-θ lens takes time. As a result, an increase in cost is caused.

On the other hand, a method of electrically correcting intensity of a laser beam with respect to the main scanning direction is also conceivable. When electric correction is performed in the main scanning direction, speed of the correction is particularly important. Recently, a technique for increasing resolution for an image and a technique for increasing speed of printing have made great advances. Therefore, in order to adapt the image forming apparatus to these techniques, it is necessary to perform the electric correction in the main scanning direction at extremely high speed.

### SUMMARY OF THE INVENTION

The invention has been devised in view of the circumstances and it is an object of the invention to provide a laser beam scanning apparatus, an image forming apparatus, and a laser beam scanning method that can correct laser beam intensity with respect to a main scanning direction on a photosensitive drum to be constant and perform electric correction at high speed.

In order to attain the object, a laser beam scanning apparatus according to an aspect of the invention includes: a laser oscillating unit that outputs a laser beam; a laser beam scanning unit that performs scanning in a main scanning direction with a laser beam and irradiates the laser beam on a photosensitive member via an optical lens; an error signal generating unit that monitors, in a predetermined period other than an image formation period, intensity of a laser beam outputted from the laser oscillating unit and generates an error signal of an error between output intensity of the laser oscillating unit and a predetermined output reference value; a correction signal generating unit that generates a correction signal for correcting intensity of a laser beam along the main scanning direction such that intensity of the laser beam in the main scanning direction on the photosensitive member is set to be a predetermined constant value; a correction signal converting unit that converts the correction signal to an adapted correction signal by attenuating the correction signal; and a laser control signal generating unit that holds, during the image formation period, a reference signal generated on the basis of the error signal and applies the adapted correction signal to the reference signal to generate a laser control signal for determining intensity of a laser beam outputted from the laser oscillating unit.

Further, in order to attain the object, an image forming apparatus according to another aspect of the invention includes: a photosensitive member; a laser beam scanning unit that scans the photosensitive member with a laser beam in order to form an electrostatic latent image on the photosensitive member; a developing unit that applies toner development to the photosensitive member on which an electrostatic latent image is formed and generates a developed image; and a fixing unit that fixes the developed image, wherein the laser beam scanning unit includes: a laser oscillating unit that outputs a laser beam; a laser beam scanning unit that performs scanning in a main scanning direction with a laser beam and irradiates the laser beam on a photosensitive member via an optical lens; an error signal generating unit that monitors, in a predetermined period other than an image formation period, intensity of a laser beam outputted from the laser oscillating unit and generates an error signal of an error between output intensity of the laser oscillating unit and a predetermined output reference value; a correction signal generating unit that generates a correction signal for correcting intensity of a laser beam along the main scanning direction such that intensity of the laser beam in the main scanning direction on the photosensitive member is set to be a predetermined constant value; a correction signal converting unit that converts the correction signal to an adapted correction signal by attenuating the correction signal; and a laser control signal generating unit that holds, during the image formation period, a reference signal generated on the basis of the error signal and applies the adapted correction signal to the reference signal to generate a laser control signal for determining intensity of a laser beam outputted from the laser oscillating unit.

Furthermore, in order to attain the object, a laser beam scanning method according to another aspect of the invention includes the steps of: outputting a laser beam from a laser oscillating unit; scanning in a main scanning direction with a laser beam and irradiating the laser beam on a photosensitive member via an optical lens; generating an error signal by monitoring, in a predetermined period other than an image formation period, intensity of a laser beam outputted from the laser oscillating unit and generating an error signal of an error between output intensity of the laser oscillating unit and a predetermined output reference value; generating a correction signal for correcting intensity of a laser beam along the main scanning direction such that intensity of the laser beam in the main scanning direction on the photosensitive member is set to be a predetermined constant value; converting the correction signal to an adapted correction signal by attenuating the correction signal; and generating a laser control signal by holding, during the image formation period, a reference signal generated on the basis of the error signal and applying the adapted correction signal to the reference signal to generate a laser control signal for determining intensity of a laser beam outputted from the laser oscillating unit.

According to the laser beam scanning apparatus, the image forming apparatus, and the laser beam scanning method according to the invention, it is possible to correct laser beam intensity in a main scanning direction on a photosensitive drum to be constant and perform electric correction at high speed.

### DESCRIPTION OF THE DRAWINGS

In the accompanying drawings:

FIG. 1 is a schematic diagram of an image forming apparatus according to an embodiment of the invention;

FIG. 2 is a diagram showing a constitution of an optical system unit and a positional relation of a photosensitive drum;

FIG. 3 is a block diagram showing an example of a functional constitution mainly for control of an optical system;

FIG. 4 is a relational diagram of a laser power output and a beam position;

FIGS. 5A to 5D are diagrams showing laser power (before correction) in a main scanning direction on the surface of the photosensitive drum;

FIG. 6 is a block diagram showing an example of a detailed constitution for performing light amount control according to a first embodiment;

FIGS. 7A to 7G are timing charts for explaining a method for light amount control according to the first embodiment;

FIG. 8 is a block diagram showing an example of a detailed constitution for performing light amount control according to a second embodiment;

FIG. 9 is a diagram for explaining a relation among voltages of a hold capacitor according to the second embodiment;

FIGS. 10A to 10G are timing charts for explaining a method for light amount control according to the second embodiment;

FIG. 11 is a graph showing an example of a relation between a voltage of the hold capacitor and an amount of laser beams;

FIGS. 12A to 12E are diagrams showing an example of a correction state in the case in which correction in the main scanning direction is performed using an 11-bit D/A converter in the second embodiment;

FIG. 13 is a block diagram showing an example of a detailed constitution for performing light amount control according to a third embodiment;

FIGS. 14A to 14E are diagrams showing an example of a correction state in the case in which correction in the main scanning direction is performed using an 8-bit D/A converter in the third embodiment; and

FIG. 15 is a block diagram showing an example of a detailed constitution for performing light amount control according to a fourth embodiment.

### DESCRIPTION OF THE EMBODIMENTS

A laser beam scanning apparatus, an image forming apparatus, and a laser beam scanning method according to the invention will be explained with reference to the accompanying drawings.

(1) Constitutions of the Image Forming Apparatus and the Laser Beam Scanning Apparatus and Basic Operations Thereof

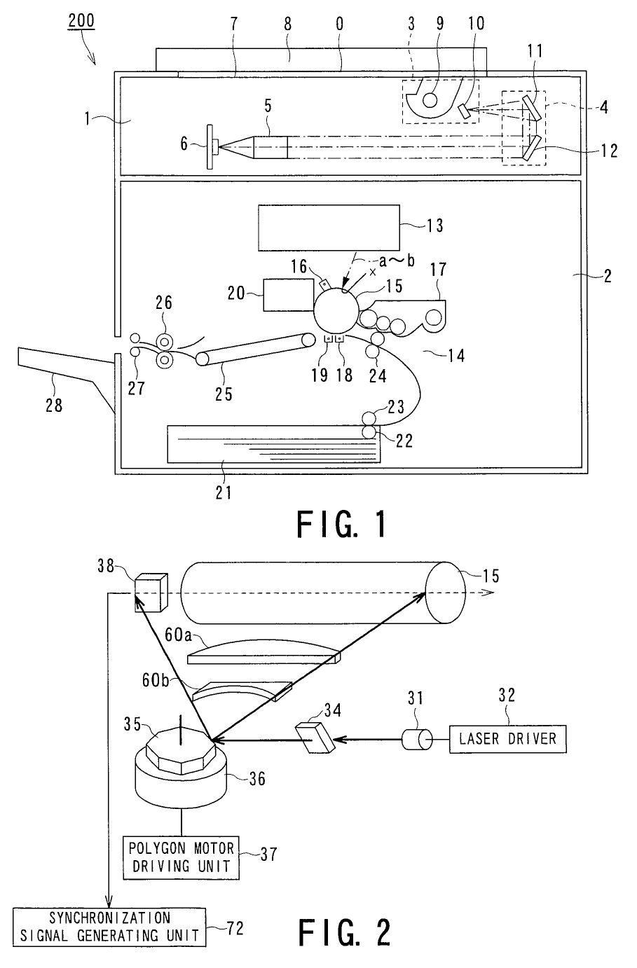

FIG. 1 is a diagram schematically showing an example of a constitution of an image forming apparatus 200, for example, a digital copying machine, to which a laser beam scanning apparatus 100 according to an embodiment of the invention is applied.

The image forming apparatus 200 includes a scanner unit 1 and a printer unit 2. In the scanner unit 1, an original 0 is placed face-down on original stand glass 7. The original 0 is pressed on the original stand glass 7 when a cover 8 for fixing an original provided to be freely opened and closed is closed.

The original 0 is irradiated by a light source 9. Reflected light from the original 0 is focused on a sensor surface of a photoelectric conversion element 6 via mirrors 10, 11, and 12 and a condensing lens 5. When a first carriage 3 including the light source 9 and the mirror 10 and a second carriage 4 including the mirrors 11 and 12 are moved in a direction from the right to the left in FIG. 1 in synchronization with a reading timing signal by a not-shown carriage driving motor to always fix an optical path length, irradiated light from the light source 9 scans the original 0.

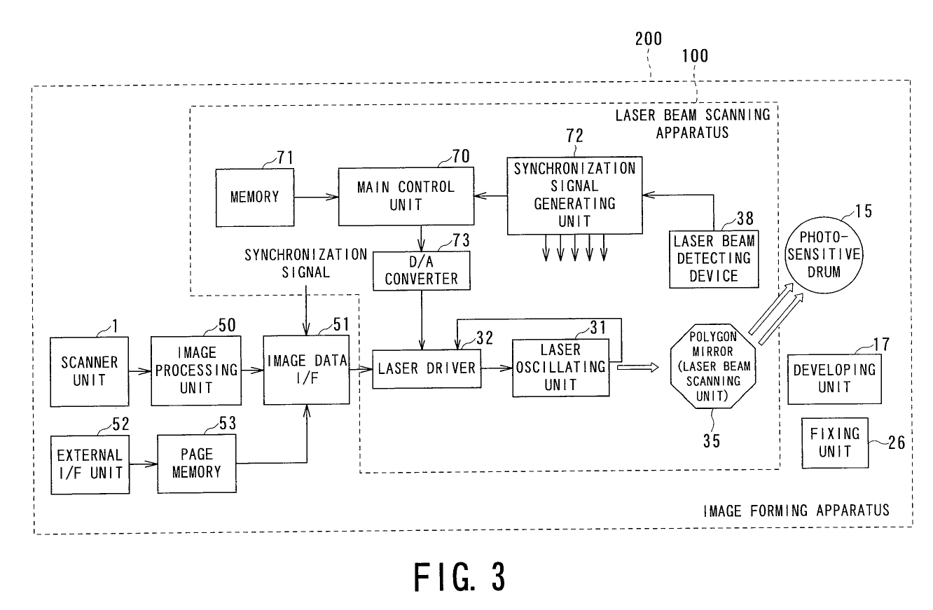

According to the scanning of the irradiated light, the original 0 placed on the original glass 7 is sequentially read line by line and converted into an analog electric signal corresponding to intensity of the reflected light by the photoelectric conversion element 6. Thereafter, the analog electric signal is converted into a digital signal indicating light and shade of an image by an image processing unit 50 (see FIG. 3) and outputted to a laser optical system unit 13.

The printer unit 2 includes the optical system unit 13 and an image forming unit 14 combined with an electrophotographic system capable of forming an image on a sheet P serving as a medium on which an image is formed. An image signal read from the original 0 by the scanner unit 1 is converted into a digital signal by the image processing unit 50 and, then, converted into a laser beam (hereinafter simply referred to as beam) from a semiconductor laser oscillator (a laser oscillating unit).

One or plural laser oscillating units provided in the optical system unit 13 perform light emission operation in accordance with a laser modulation signal outputted from the image processing unit 50 and generate beams. These beams are reflected by a polygon mirror to be scanning light and outputted to the outside of the unit. A detailed constitution of the optical system unit 13 will be described later.

The beams outputted from the optical system unit 13 are focused as spot light having necessary resolution at a point of an exposure position X on a photosensitive drum (a photosensitive member) 15 serving as an image bearing member and scan the photosensitive drum 15 in a main scanning direction (a rotation axis direction of the photosensitive drum). When the photosensitive drum 15 further rotates, an electrostatic latent image corresponding to the image signal is formed on the photosensitive drum 15.

Around the photosensitive drum 15 serving as an image bearing member for forming an image, a charger 16 that charges the surface of the photosensitive drum 15, a developing device (a developing unit) 17, a transfer charger 18, a peeling charger 19, and a cleaner 20 are arranged. The photosensitive drum 15 is driven to rotate at predetermined outer peripheral speed by a not-shown driving motor and charged by the charger 16 provided to be opposed to the surface of the photosensitive drum 15. The beams are spot-focused side by side in a sub-scanning direction (a direction in which the surface of the photosensitive drum moves) at the point of the exposure position X on the photosensitive drum 15 charged.

When light is irradiated on the exposure position X on the photosensitive drum 15 charged, a potential in that portion drops and the dropping potential forms an image. In other words, an electrostatic latent image is formed. A toner serving as a developer from the developing unit 17 is used for development by the photosensitive drum 15. A toner image is formed on the photosensitive drum 15 by the development. The toner image is transferred onto the sheet P, which is supplied from a sheet feeding system, at a point of a transfer position by the transfer charger 18.

The sheet feeding system separates the sheets P in a sheet feeding cassette 21 provided in the bottom section one by one with a sheet feeding roller 22 and a separating roller 23. Thereafter, the sheet P is sent to a registration roller 24 and supplied to the transfer position at predetermined timing. A sheet conveying mechanism 25, a fixing device (a fixing unit) 26, and a discharge roller 27 that discharges the sheet P on which an image is formed are arranged on a downstream side of the transfer charger 18. In the fixing device 26, the toner image is fixed on the sheet P on which the toner image is transferred. Thereafter, the sheet P is discharged to a sheet discharge tray 28 on the outside through the sheet discharge roller 27.

A residual toner on the photosensitive drum 15, which has completed the transfer of the image onto the sheet P, is removed by the cleaner 20. The photosensitive drum 15 returns to an initial state and comes into a standby state for the next image formation. An image forming operation is continuously performed by repeating the process operation described above.

The optical system unit 13 will be explained.

FIG. 2 shows a constitution of the optical system unit 13 and a positional relation of the photosensitive drum 15. The optical system unit 13 includes a laser oscillating unit 31 and performs image formation using a beam outputted from the laser oscillating unit 31.

The laser oscillating unit 31 is driven by a laser driver 32 on the basis of data modulated by a pulse width modulation system. A beam outputted from the laser oscillating unit 31 passes through a not-shown collimator lens and, then, passes through a half mirror 34 to be made incident on the polygon mirror 35 serving as a rotary polygon mirror.

The polygon mirror 35 is rotated at constant speed by a polygon motor 36 controlled from a polygon motor driving unit 37. Consequently, reflected light from the polygon mirror 35 changes into scanning light at angular speed set by the rotating speeds of the polygon motor 36, passes through f-θ lenses 60a and 60b, and scans a light-receiving surface of a laser beam detecting device 38 and the photosensitive drum 15 at constant speed.

The laser beam detecting device 38 is disposed near the end of the photosensitive drum 15 such that a position of the light-receiving surface is equivalent to a position of the surface of the photosensitive drum 15. The laser beam detecting device 38 detects passing timing of a beam.

The laser beam detecting device 38 may be disposed such that the a beam used for scanning by the polygon mirror 35 is reflected using a not-shown return mirror and an extended line of the beam reflected by the return mirror and the light-receiving surface of the laser beam detecting device 38 are equivalent to the surface of the photosensitive drum 15.

Control for light-emitting timing (image formation position control in the main scanning direction) is performed on the basis of a detection signal from the laser beam detecting device 38. In order to generate a signal for performing these controls, a synchronization signal generating unit 72 is connected to the laser beam detecting device 38.

A control system will be explained.

FIG. 3 is a diagram showing an example of a functional constitution of the image forming apparatus 200 according to this embodiment, In particular, an example of a functional constitution of the laser beam scanning apparatus 100 that perform scanning control is shown in detail.

The image forming apparatus 200 includes a scanner unit 1, the image processing unit 50, an image data I/F 51, the laser beam scanning apparatus 100, the photosensitive drum 15, a developing unit 17, and a fixing unit 26. Besides, the image forming apparatus 200 includes an external I/F unit 52 and a page memory 53.

The laser beam scanning apparatus 100 includes a main control unit 70, a memory 71, a synchronization signal generating unit 72, the laser beam detecting device 38, a D/A converter 73, the laser driver 32, the laser oscillating unit 31, and the polygon mirror (a laser beam scanning unit) 35.

Operations of the image forming apparatus 200 constituted as described above will be schematically explained.

First, when the image forming apparatus 200 operates as a copying machine, an image of the original 0 (see FIG. 1) set on the original stand 7 is read by the scanner unit 1 and sent to the image processing unit 50. The image processing unit 50 applies image processing such as shading correction, various kinds of filtering processing, gradation processing, and gamma correction to an image signal from the scanner unit 1.

Image data outputted from the image processing unit 50 is sent to the image data I/F 51. The image data I/F 51 synchronizes the image data according to a synchronization signal generated by the synchronization signal generating unit 72 and outputs the image data to the laser driver 32.

The synchronization signal generating unit 72 generates a timing signal that synchronizes with timing at which respective beams pass over the laser beam detecting device 38. The image data is outputted from the image data I/F 51 to the laser driver 32 in synchronization with this timing signal.

The synchronization signal generating unit 72 includes a generation circuit for a sampling signal for the APC function and a logic circuit for causing the laser oscillating unit 31 to perform a light-emitting operation when the respective beams pass over the laser beam detecting device 38 and detecting a main scanning direction position of the beams. The APC function means a function of forcibly causing the laser oscillating unit 31 to perform light-emitting operation in a time period (hereinafter referred to as APC period because an APC operation is performed in this period) other than time when beams irradiate the image formation area on the photosensitive drum 15 and controlling output power of the respective beams on the basis of a monitor value at this time.

When the image data is transferred in synchronization with scanning of the beams using the synchronization signal outputted from the synchronization signal generating unit 72 in this way, image formation (in a correct position) synchronized in the main scanning direction is performed.

The image forming apparatus 200 is constituted to be capable of operating not only as the copying machine but also as a printer. In this case, the image forming apparatus 200 performs image formation using image data inputted from the outside via the external I/F 52 connected to the page memory 53. The image data inputted from the external I/F 52 is temporarily stored in the page memory 53 and, then, sent to the laser driver 32 via the image data I/F 51.

The laser driver 32 of the laser beam scanning apparatus 100 causes the laser oscillating unit 31 to emit laser beams in accordance with the image data. Besides, the laser driver 32 also has a function of forcibly performing the light-emitting operation of the laser oscillating unit 31 regardless of the image data according to a forcible light emission signal from the main control unit 70.

The polygon mirror 35 is a mirror for using the beams outputted from the laser oscillating unit 31 to scan the photosensitive drum 15 in the main scanning direction. The beams are repeatedly used for scanning the photosensitive drum 15 at high speed in the main scanning direction in a state in which the beams are arranged on the drum 15 in parallel by the rotation of the polygon mirror 35.

The rotational driving for the polygon mirror 35 is performed according to the control from the main control unit 70. Control signals for rotation start, rotation stop, and switching the rotating speed from the main control unit 70 are outputted to the polygon motor driving unit 37 (see FIG. 2) and drive to rotate the polygon motor 36.

An electrostatic latent image is formed on the photosensitive drum 15 by the beams irradiated on the photosensitive drum 15. This electrostatic latent image is developed by the developing unit 17. A developed image (a toner image) developed on the photosensitive drum 15 is transferred onto recording paper. Then, a toner is fixed on the recording paper by the fixing unit 26.

(2) Correction in a Main Scanning Direction (First Embodiment)

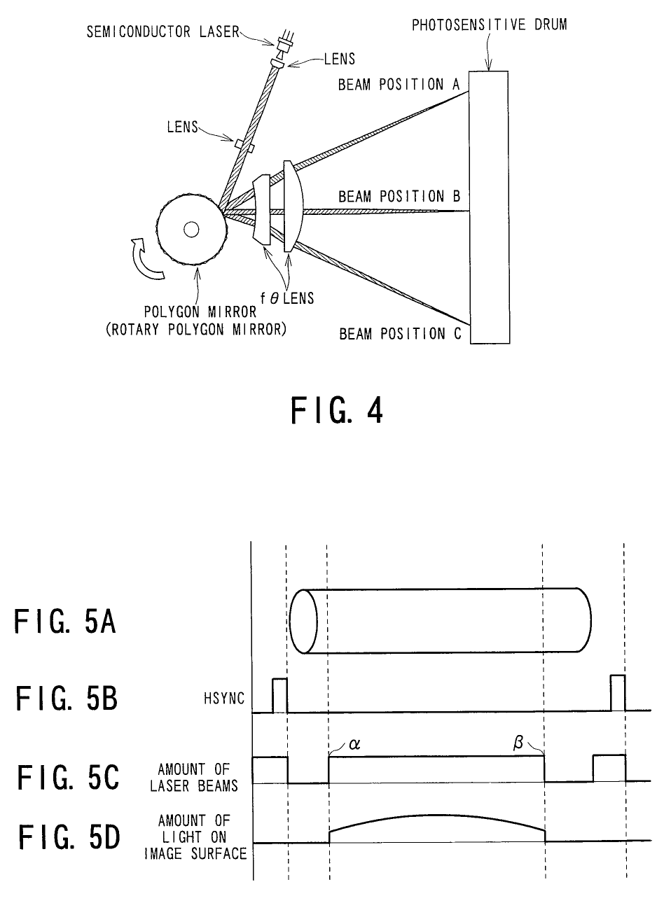

FIG. 4 is a diagram showing a path leading from the laser oscillating unit 31 to the photosensitive drum 15.

An angle of incidence of a beam to the main scanning direction of the f-θ lens is close to vertical near the center of the lens (a beam position B). The laser beam is made incident obliquely at a larger angle in positions closer to the ends of the lens (beam positions A and C). Therefore, a transmission loss of the lens with respect to the main scanning direction in one line increases from the center of the lens to the ends of the lens. As a result, even if a laser power output of a laser beam source is fixed, laser power on the surface of a photosensitive drum is large in the center and small at the ends.

FIGS. 5A to 5D are diagrams illustrating a situation in which laser power on the surface of the photosensitive drum is not uniform because of the reason described above.

FIG. 5A is a diagram schematically showing the photosensitive drum. FIG. 5B is a horizontal synchronization signal (HSYNC) generated on the basis of a detection signal detected by the laser beam detecting device 38 when a beam is used for scanning in the main scanning direction. Image data is inputted to the laser driver 32 in synchronization with this horizontal synchronization signal.

FIG. 5C shows an amount of laser beams outputted from the laser oscillating unit 31. FIG. 5C indicates that, when there is no correction in the main scanning direction, a fixed amount of laser beams is outputted from the laser oscillating unit 31 during an image formation period (a period indicated by a range from a point α to a point β in FIG. 5C).

As for laser power on the surface of the photosensitive drum (an amount of light on an image surface), as shown in FIG. 5D, an amount of laser beams is large in the center where a transmission loss is small and the amount of laser beams is small in positions closer to the ends where a transmission loss is large because of a difference of transmission losses in the main scanning direction of the f-θ lens.

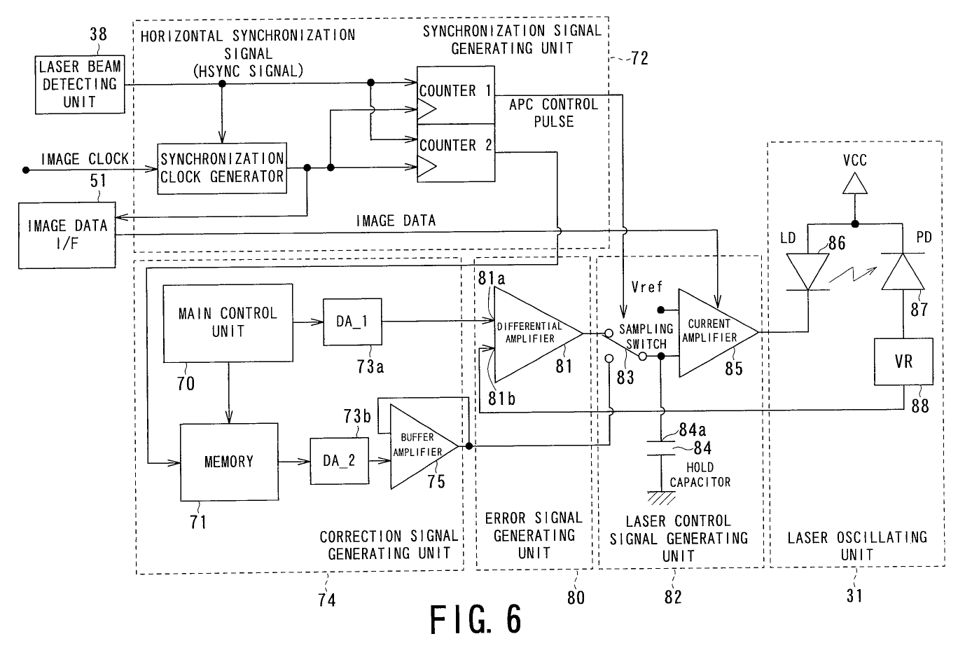

FIG. 6 is a diagram showing an example of a detailed constitution of a first embodiment for correcting an amount of laser beams of the laser oscillating unit 31 in the main scanning direction in order to solve the problems described above.

FIG. 6 is a diagram showing an example of a detailed constitution for light amount control for the laser oscillating unit 31 in the laser beam scanning apparatus 100 of the image forming apparatus 200.

The example of the constitution according to the first embodiment shown in FIG. 6 is a form constituted to be capable of setting an amount of laser beams to a predetermined value according to the APC function and also performing correction in the main scanning direction during the image formation period.

An amount of light of the laser oscillating unit 31 is set by a correction signal generating unit 74, an error signal generating unit 80, a laser control signal generating unit 82, and the laser oscillating unit 31.

The error signal generating unit 80 and the laser control signal generating unit 82 constitute the laser driver 32 (see FIG. 3).

More specifically, an amount of light of the laser oscillating unit 31 is determined according to an amount of charges stored in a hold capacitor (a capacitor) 84 provided in the laser control signal generating unit 82, that is, a voltage. A current amplifier 85 of the laser control signal generating unit 82 converts a voltage at a charge/discharge terminal 84a of the hold capacitor 84 into a current to drive a laser diode 86 of the laser oscillating unit 31 with the current.

On the other hand, a switch (a switch) 83 of the laser control signal generating unit 82 is connected to a buffer amplifier 75 side of the correction signal generating unit 74 in a period during image formation and connected to an output side of a differential amplifier 81 of the error generating unit 80 in an APC period.

The differential amplifier 81 outputs a difference (an error signal) between a voltage at a reference input terminal 81a thereof and a voltage at a differential input terminal 81b.

An output of a photo-detector 87, which is provided next to the laser diode 86 and detects output power of the laser diode 86, is connected to the differential input terminal 81b via a sensitivity adjusting unit 88.

Therefore, during the APC period, charge and discharge are performed between the differential amplifier 81 and the hold capacitor 84 to determine a voltage of the hold capacitor 84 until output power of the laser diode 86 comes to coincide with a predetermined output power value set according to a voltage at the reference input terminal 81a of the differential amplifier 81 (a value set for a D/A converting unit 73a from the main control unit 70) (an error is reduced to zero).

On the other hand, during the image formation period, the sampling switch 83 is connected to the buffer amplifier 75. Therefore, during the image formation period, the hold capacitor 84 is further charged and discharged according to an output voltage of the buffer amplifier 75 with the voltage of the hold capacitor 84 set during the APC period as a reference (as an initial value).

During the image formation period, the current amplifier 85 is switched according to image data (e.g., image data subjected to pulse width modulation) outputted from the image data I/F unit 51. An output current corresponding to an input voltage of the current amplifier 85 (i.e., a voltage at the charge/discharge terminal 84a of the hold capacitor 84) is switched (on and off) according to the image data to drive the laser diode 86 to emit light.

In this way, it is possible to set an amount of light during the image formation period according to a voltage at the reference input terminal 81a of the differential amplifier 81 and an output voltage of the buffer amplifier 75.

The output voltage of the buffer amplifier 75 is an output voltage of a D/A converter 73b. The output voltage of the D/A converter 73b is determined by reading out data stored in advance in the memory 71 under the control by the main control unit 70 and setting the data in the D/A converter 73b.

Therefore, it is possible to correct output power of the laser diode 86 according to a value of data stored in the memory 71. In the first embodiment, correction data in the main scanning direction is stored in the memory 71. Correction in the main scanning direction of an amount of laser beams of the laser oscillating unit 31 is performed by reading out this correction data and applying the correction data to the charge/discharge terminal 84a of the hold capacitor 84a during the image formation period.

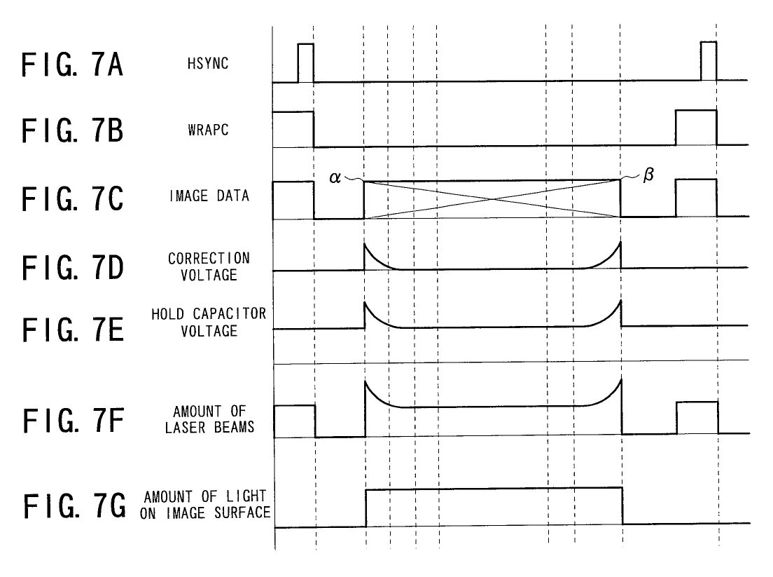

FIG. 7 is a timing chart specifically illustrating a method for light amount control according to the first embodiment.

First, the main control unit 70 (CPU) rotates the polygon mirror motor 36 and, when the polygon mirror motor 36 comes into steady rotation, outputs a laser forcible light emission signal (not shown).

Simultaneously with the output of the laser forcible light emission signal, an APC control pulse (FIG. 7B) (high level), which is a control signal for the sampling switch 83, is also outputted. The sampling switch 83 is connected to the differential amplifier 81 side (a sample state).

If the hold capacitor 84 is completely discharged, the laser diode 86 does not emit light immediately. Thus, an output of the photo-detector 87 is small. As a result of comparing the output with an output of the D/A converter 73a (a predetermined output power value set by the main control unit 70) with the differential amplifier 81, the differential amplifier 81 outputs a positive voltage and charges the hold capacitor 84.

When the hold capacitor 84 is charged and the laser diode 86 starts to emit light of an amount close to a predetermined amount of light, a scanning beam traverses the laser beam detecting device 38 and a horizontal synchronization signal (an HSYNC signal) (FIG. 7A) is outputted.

When the HSYNC signal is outputted, a counter 1 of the synchronization signal generating unit 72 is reset. At the same time, an APC pulse signal falls to a Low level (the connection of the sampling switch 83 is changed from the differential amplifier 81 side to the buffer amplifier 75 side). At the same time, the counter 1 starts to count an image clock synchronizing with HSYNC. When the image clock reaches a predetermined count number, the APC pulse signal is outputted again (the APC pulse signal is set to a High level).

In order to change an amount of laser beams during the image formation period (a period indicated by a range from a point α to a point β in FIG. 7C), a voltage at the charge/discharge terminal 84a of the hold capacitor 84 (i.e. an input voltage of the current amplifier 85) only has to be changed.

In FIG. 6, the buffer amplifier 75 of the correction signal generating unit 74 is connected to the memory 71 via the D/A converter 73b. An amount of light amount change in the main scanning direction is stored in this memory 71 as digital data (e.g., data for setting a large amount of laser beams at upstream and downstream ends in the scanning direction compared with positions near the center in the scanning direction is recorded to compensate a change in a transmittance of a lens).

The buffer amplifier 75 functions as a voltage follower. An output of the D/A converter 73b is buffered by this voltage follower and connected to the sampling switch 83 during the image formation period.

Therefore, during the image formation period, the hold capacitor 84 is charged and discharged according to the output of the D/A converter 73b to change an amount of laser beams.

When the horizontal synchronization signal (HSYNC) is outputted, a counter 2 is also reset and starts to count an image clock synchronizing with the horizontal synchronization signal.

An output of the counter 2 is connected to the memory 74. For example, in the case of a setting in which the counter 2 outputs a counter output every time an image clock is inputted, if light amount change data in the main scanning direction in units of one pixel is recorded in the memory 74, the memory 74 can set correction data for every one pixel in the D/A converter 73b.

As a result, a correction voltage (FIG. 7D) in the main scanning direction outputted from the D/A converter 73b is applied to the hold capacitor 84 via the buffer amplifier 75 and the sampling switch 83 (FIG. 7E). It is possible to change an amount of laser beams in units of one pixel with respect to the main scanning direction (FIG. 7F).

If change (correction) data for compensating a transmittance of an f-θ lens and making an amount of light on an image surface of the photosensitive drum constant is recorded in the memory 71, the laser diode 86 emits light according to the change (correction) data. Therefore, it is possible to make an amount of light on the image surface constant as shown in FIG. 7G.

By repeating the operations described above, making an amount of light on the image surface constant is always possible. Thus, it is possible to form a high-quality image without density unevenness.

(3) Correction in the Main Scanning Direction (a Second Embodiment)

Recently, there are increasing requests for high resolution and high-speed in an image forming apparatus. There is a room of improvement for the first embodiment in the following points.

In the form described above, in performing light amount change (light amount correction) in the main scanning direction, it is necessary to switch a usual state of APC control performed in the APC period and light amount change (a light amount correction state) in the main scanning direction performed in the image formation period using a switching element (the sampling switch 83).

Functions required of this switching element are, for example, as described below.

<1> Switching speed is high.

<2> An insulation resistance value between the switching element and an unconnected terminal is large.

<3> A connection resistance (On resistance) between the switching element and a connected terminal is small.

Concerning <1> above, when speed in the switching is low, it is impossible to perform light amount change (correction) at a predetermined point. In particular, this causes a problem on the upstream side in the main scanning direction. Since optical efficiency falls at both ends of a lens as shown in FIG. 7D and the like, an amount of optical amount change (correction) is the largest at both the ends of the lens. If appropriate light amount change (correction) cannot be performed at this point, an image quality is markedly deteriorated (density unevenness occurs).

Concerning <3>, a problem occurs in performing light amount change (correction) in units of a pixel. At the time of light amount change (correction), the sampling switch 83 connects the buffer amplifier 75 and the charge/discharge terminal 84a of the hold capacitor 84. When a connection resistance of the sampling switch 83 (an ON resistance: Ron) is large, speed of charge and discharge (i.e. a time constant) depends on a product of the On resistance (Ron) and a capacitance of the hold capacitor 84 (Chold). In other words, when the On resistance is large, charge and discharge take time. Thus, similarly, it is impossible to obtain a desired amount of laser beams and density unevenness occurs. When the time constant is large, since a difference occurs in a desired amount of light amount change (a correction amount) (an input value), a value of an amount of laser beams (an output value) actually emitted, and a point (a position in the scanning direction), proper change (correction) cannot be performed. This causes deterioration in an image quality

For example, when the On resistance is Ron=10Ω and a capacitance of the hold capacitor 84 is Chold=0.0047 μF, a time constant T1 is represented as follows.
T1=Ron×Chold=10Ω×0.0047 μF=4.7 ns
In general, it is said that time about five times as long as a time constant is required for a physical phenomenon to completely converge (5T1=4.7 ns*5=23.5 ns).

Therefore, at least about 23 ns is required from time when an amount of light amount change (a correction amount) is set until the correction amount set is completely realized. Therefore, for example, it is impossible to cope with high-speed processing of 20 ns/pixel or less (50 MHz/pixel or more).

It is evident that the problem is caused by the switching element. Thus, in the second embodiment, the problem is solved by adopting a form in which the switching element is not used for light amount correction in the main scanning direction.

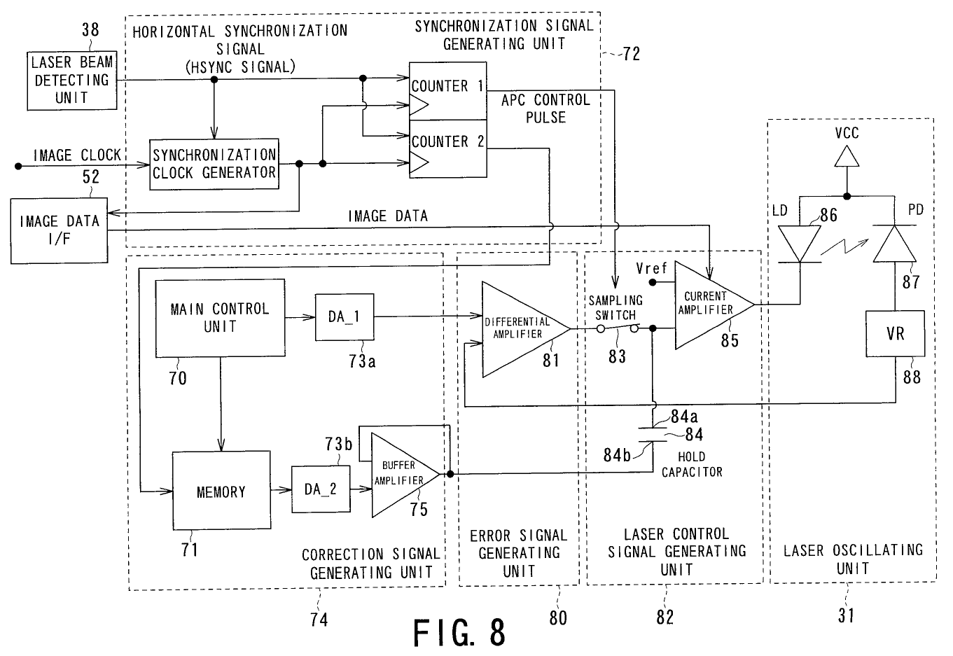

FIG. 8 is a block diagram showing an example of a constitution for realizing light amount control according to the second embodiment. The second embodiment is different from the first embodiment (FIG. 6) in that the switching element (the sampling switch 83) is not used for light amount correction in the main scanning direction during an image period and that a correction signal (a correction voltage) used for light amount correction in the main scanning direction is applied to the reference potential terminal. 84b of the hold capacitor 84.

In other words, an output of the buffer amplifier 75 of the correction signal generating unit 74 is connected to the reference potential terminal. 84b (grounded in the first embodiment) of the hold capacitor 84 without the intervention of the switching element (the sampling switch 83). This is a form in which a potential at an input terminal of the current amplifier 85 is controlled to change an amount of laser beams by controlling a reference potential of a capacitor while keeping a voltage held by the hold capacitor 84 rather than directly charging and discharging the hold capacitor 84.

With this method, since the switching element is not interposed in a light amount change path in the main scanning direction, the problems of an On resistance and turn on/off time do not occur. Compared with the example described above, for example, it is possible to cope with speed ten times as high as that in the example.

As in the first embodiment, during the APC period, the sampling switch 83 is connected to the differential amplifier 81 and the hold capacitor 84 is charged and discharged to obtain a desired amount of light set from the main control unit 70.

In this case, the output of the buffer amplifier 75 is set to be 0 volt. Therefore, an operation during the APC period is an operation substantially equivalent to that in the first embodiment in which the reference potential terminal 84b of the hold capacitor 84 is grounded.

On the other hand, during the image formation period, a correction voltage is outputted from the buffer amplifier 75 and applied to the reference potential terminal 84b of the hold capacitor 84.

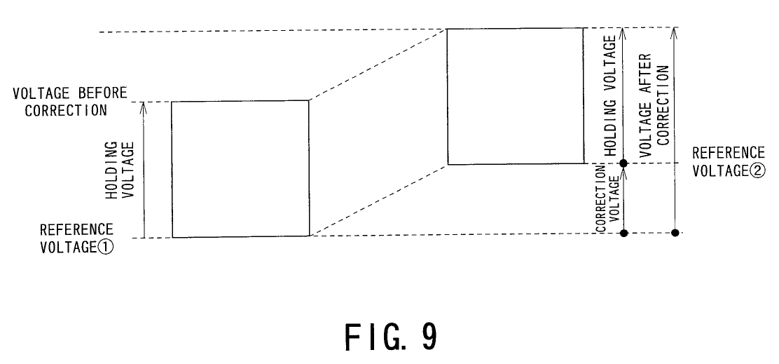

FIG. 9 is a diagram schematically showing a relation among voltages of the hold capacitor 84. During the APC period (a diagram on the left in FIG. 9), a voltage at the reference potential terminal 84b is 0 volt (in the figure, a voltage indicated by a reference voltage <1>). A potential at the charge/discharge terminal 84a of the hold capacitor 84 is a holding voltage depending on charge and discharge during the APC period.

On the other hand, during the image formation period, a potential at the charge/discharge terminal 84a of the hold capacitor 84 is increased by a correction voltage outputted from the buffer amplifier 75 to be a voltage obtained by adding the holding voltage and a voltage at the reference potential terminal 84b.

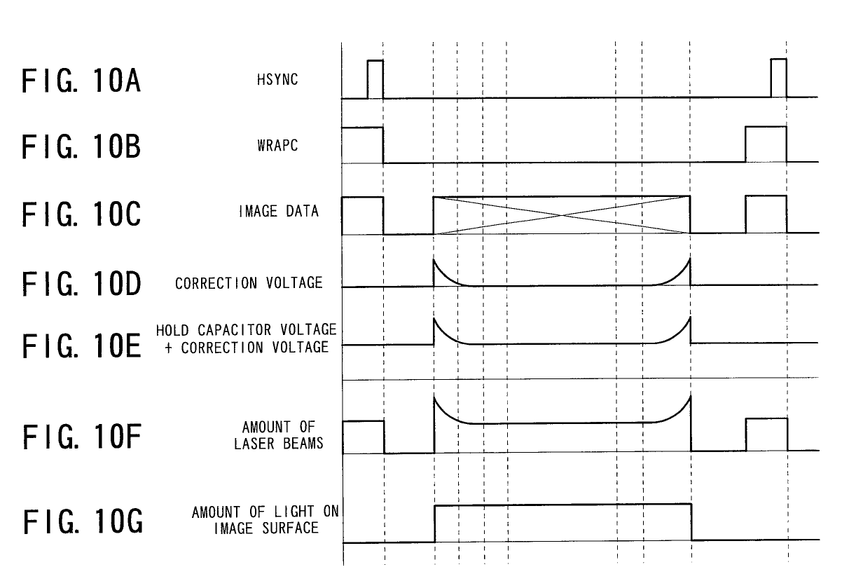

FIGS. 10A to 10G are timing charts showing a method for light amount control in the main scanning direction according to the second embodiment. In appearance, the timing chart is the same as the timing chart (FIG. 7) according to the first embodiment. However, a waveform shown in FIG. 7E (an input voltage of the current amplifier 85) is a voltage itself of the hold capacitor 84. In other words, the waveform changes when the buffer amplifier 75 charges and discharges the hold capacitor 84 via the sampling switch 83.

On the other hand, in the second embodiment, a waveform show in FIG. 10E (an input voltage from the current amplifier 85) is generated when a correction voltage outputted from the buffer amplifier 75 is directly applied (added) to a voltage of the hold capacitor 84.

Therefore, in the second embodiment, there is no influence of an On resistance of the sampling switch 83. This makes it possible to set a correction voltage at an input of the current amplifier 85 at extremely high speed.

(4) Adaptation of a Dynamic Range to Correction in the Main Scanning Direction (Third and Fourth Embodiments)

When a correction voltage in the main scanning direction is applied to the hold capacitor 84, it is necessary to take into account resolution and a dynamic range of the correction voltage.

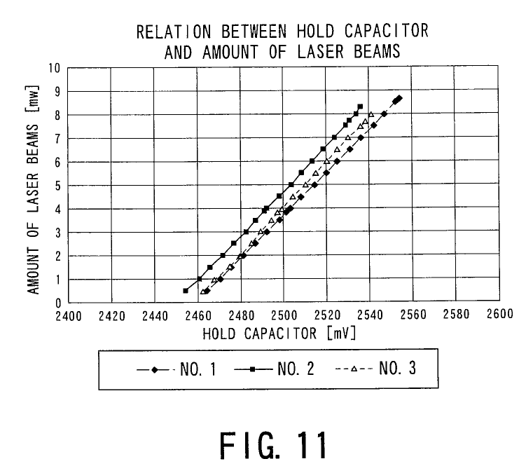

FIG. 11 is a graph of a relation between a voltage value (on an abscissa) of the hold capacitor 84 and an amount of laser beams at that point (on an ordinate). From this graph, it is possible to read a voltage value (voltage sensitivity) of the hold capacitor 84 necessary for changing the amount of laser beams by 1 mW. It is seen from FIG. 11 that the voltage sensitivity is about 0.01 [V/mW]. In other words, an amount of laser beams greatly changes with a change in a micro-voltage.

A degree of resolution required for light amount change (light amount correction) depends on mainly characteristics of an optical system. It is known that, when a general-purpose optical system is used, a transmission loss of the optical system increases about 20% in portions at the ends of the optical system where is the largest compared with the center thereof where a transmission loss is small. In other words, it is likely that an amount of light in the main scanning direction is changed (corrected) at least about 20%.

When it is assumed that resolution of the D/A converter 73b (see FIG. 8) used for correction in the main scanning direction is 8 bits and a range of a correction voltage is in a range of 0 volt to 5 volts, resolution of the correction voltage is 0.0196 [V] (5[V]÷255=0.0196[V]). When the voltage sensitivity (0.01[V/mW]) of an amount of light described above is applied to this resolution, resolution of a corrected amount of light is about 2 mW.

This means that, when it is assumed that an, amount of laser beam emission at the time of image formation is 4 mW, only correction in units of 50% can, be performed.

When a D/A converter with higher resolution, for example, an 11-bit D/A converter is used, voltage resolution is 0.00244 [V] (5[V]÷2047=0.00244[V]). In terms of resolution of an amount of light, this is about 0.244 mW. Similarly, when it is assumed that an amount of laser beam emission is 4 mW, it is possible to perform correction in units of about 6%.

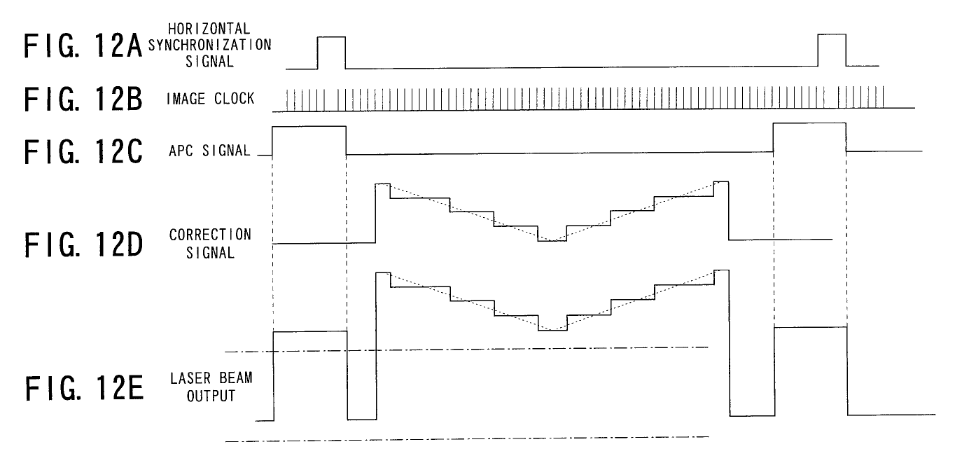

FIGS. 12A to 12E are illustration charts in the case in which light amount change (correction) in the main scanning direction is performed using the 11-bit D/A converter. FIG. 12D shows a correction voltage and FIG. 12E shows an amount of laser beams. A shape of a correction curve is assumed to be a linear V-shaped correction curve for convenience of explanation of resolution.

Since a unit of the light amount change (the light amount correction) is coarse (about 6%), ideal light amount change (light amount correction) cannot be performed. Moreover, since an amount of change at the time of the light amount change (the light amount correction) is large, this may lead to deterioration in an image quality. Since an amount of change in a boundary portion where an amount of light changes is large, the light amount change (the light amount correction) is likely to lead to density unevenness and a vertical streak to cause deterioration in an image quality.

In order to improve resolution and obtain a smoother light amount change, a high-resolution (multi-bit) D/A converter only has to be used. However, in general, a high-speed/high-resolution D/A converter is expensive. This leads to a sharp rise in prices of a laser beam scanning apparatus and an image forming apparatus.

Thus, a laser beam scanning apparatus and an image forming apparatus according to a third embodiment adopt a constitution with which it is possible to obtain high resolution while using an inexpensive D/A converter, for example, a D/A converter of about 8 bits.

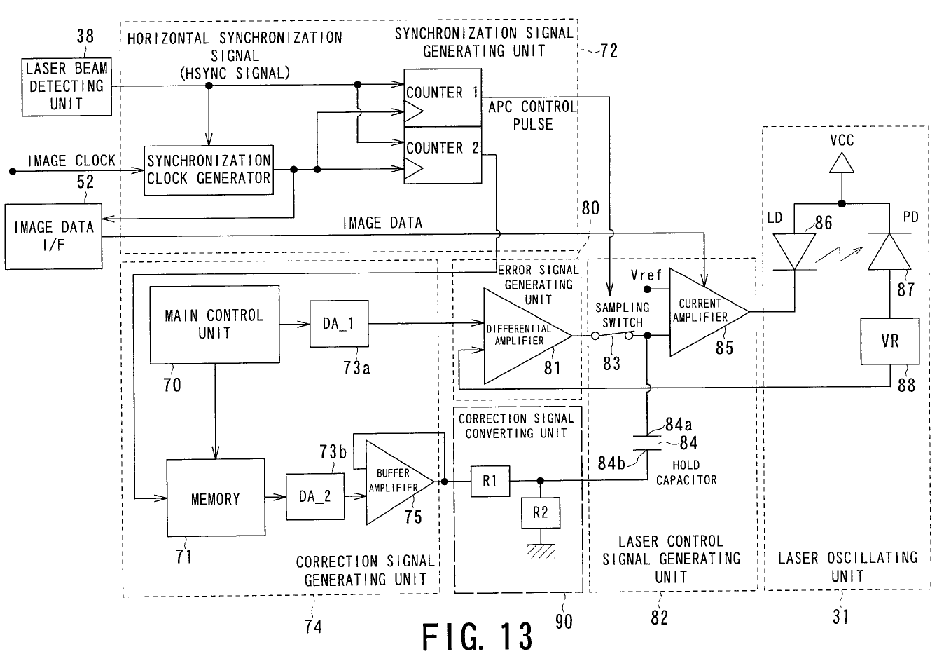

FIG. 13 is a diagram showing a detailed constitution concerning light amount control by the laser beam scanning apparatus and the image forming apparatus according to the third embodiment.

The third embodiment is different from the second embodiment (FIG. 8) in that a correction signal converting unit 90 is provided between the output of the D/A converter 73b for a correction voltage in the main scanning direction and the hold capacitor 84.

The correction signal converting unit 90 is constituted by, for example, an attenuator including resistance elements R1 and R2. Output voltage Vout of the buffer amplifier 75 is converted into a voltage Vcref at the reference potential terminal 84b of the hold capacitor 84 by this attenuator according to the next expression.
Vcref=Vout×{R2÷(R1+R2)}

For example, assuming that R1=300 kΩ and R2=1 kΩ, when the attenuator is installed, an output voltage of the buffer amplifier 75 is attenuated to about 1/300 and applied to the reference potential terminal 84b of the hold capacitor 84.

Therefore, even when the 8-bit D/A converter is used, voltage resolution is about 65 [μV] (5[V]÷255÷300=65 [μV]). As resolution of an amount of light, resolution of about 6.5 [μW](0.01 [V/mW]÷65 [μV]=65 [μW]) is obtained.

This means that, even when an amount of laser beam emission at the time of image formation is 4 mW, it is possible to change (correct) an amount of light in the main scanning direction in units of 0.16% (6.5[μW]÷4 [mW]×100=0.16%).

Whereas the amount of light can only be changed in units of about 6% in the second embodiment, resolution is improved to about 0.16% in the third embodiment.

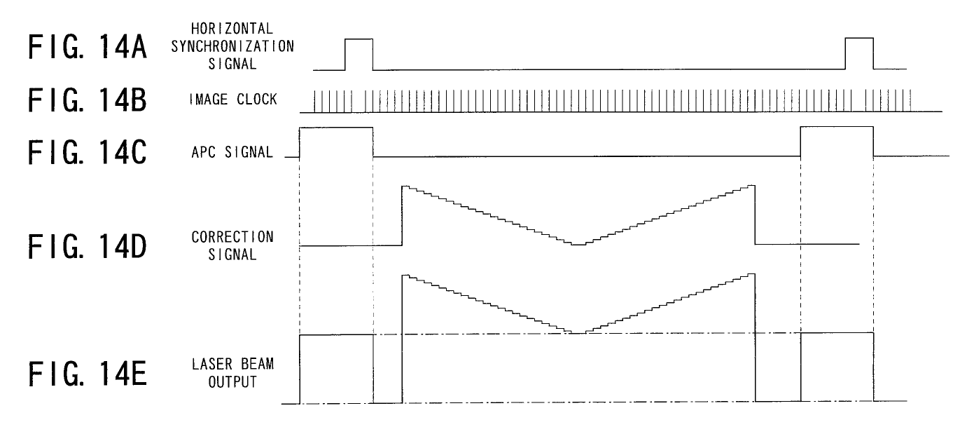

FIGS. 14A to 14E are illustration charts in the case in which light amount change (correction) in the main scanning direction in the third embodiment is performed. FIG. 14D shows a correction voltage and FIG. 14E shows an amount of laser beams. As a shape of a correction curve, the same linear V-shaped correction curve as the illustration in FIG. 12 is used. It is seen that resolution is improved compared with FIG. 12 and the correction curve (the V-shaped correction curve) is realized substantially smoothly.

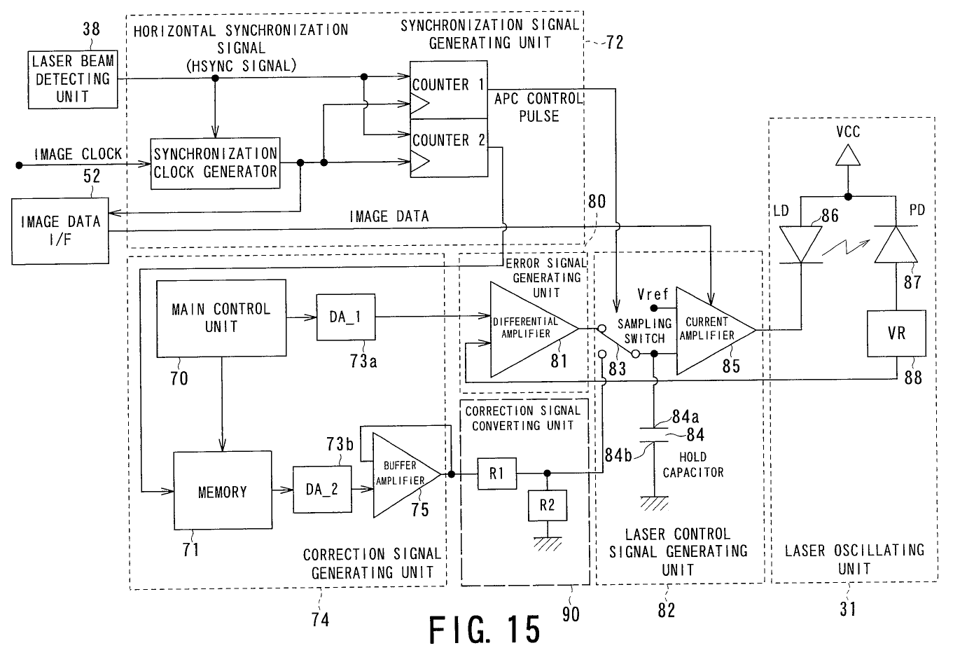

FIG. 15 is a diagram showing an example of a detailed constitution according to a fourth embodiment. In the fourth embodiment, the correction signal converting unit 90 is added to the first embodiment (see FIG. 6). In this case, since a correction voltage is connected to the charge/discharge terminal 84a of the hold capacitor 84, although the fourth embodiment is inferior to the third embodiment in terms of correction speed, an effect equivalent to that in the third embodiment is obtained in terms of resolution of a correction signal.

As explained above, according to the laser beam scanning apparatus, the image forming apparatus, and the laser beam scanning method according to the embodiments, it is possible to correct laser beam intensity with respect to the main scanning direction on the photosensitive drum to be constant and perform the correction at high speed.

Since the correction signal converting unit (the attenuator) is provided at the output of the D/A converter for correction in the main scanning direction to adapt a range of a correction voltage to a dynamic range in a range that should be corrected, it is possible to obtain high resolution with an inexpensive D/A converter.

The invention is not limited to the embodiments themselves. It is possible to modify and embody the elements without departing from the spirit of the invention when the invention is carried out. It is possible to form various inventions according to appropriate combinations of the plural components disclosed in the embodiments. For example, several components may be deleted from all the components described in the embodiments. Moreover, the components in the different embodiments may be appropriately combined.

What is claimed is:

1. A laser beam scanning apparatus comprising:
a laser oscillating unit that outputs a laser beam;
a laser beam scanning unit that performs scanning in a main scanning direction with a laser beam and irradiates the laser beam on a photosensitive member via an optical lens;
an error signal generating unit that monitors, in a predetermined period other than an image formation period, intensity of a laser beam outputted from the laser oscillating unit and generates an error signal of an error between output intensity of the laser oscillating unit and a predetermined output reference value;
a correction signal generating unit that generates a correction signal for correcting intensity of a laser beam along the main scanning direction such that intensity of the laser beam in the main scanning direction on the photosensitive member is set to be a predetermined constant value;
a correction signal converting unit that converts the correction signal to an adapted correction signal by attenuating the correction signal; and
a laser control signal generating unit that holds, during the image formation period, a reference signal generated on the basis of the error signal and applies the adapted correction signal to the reference signal to generate a laser control signal for determining intensity of a laser beam outputted from the laser oscillating unit.

2. A laser beam scanning apparatus according to claim 1, wherein the correction signal converting unit is configured with an attenuator.

3. A laser beam scanning apparatus according to claim 1, wherein
the laser control signal generating unit includes a switch and a capacitor,
in the predetermined period other than the image formation period, the laser control signal generating unit generates the reference signal by closing the switch and charging the error signal in and discharging the error signal from the capacitor, and
in the image formation period, the laser control signal generating unit opens the switch to hold the reference signal in the capacitor and applies the adapted correction signal to the capacitor to generate the laser control signal.

4. A laser beam scanning apparatus according to claim 1, wherein
the laser control signal generating unit includes:
a switch; and
a capacitor that has a charge/discharge terminal connected to the switch and a reference potential terminal,
in the predetermined period other than the image formation period, the laser control signal generating unit generates the reference signal by closing the switch and charging the error signal in and discharging the error signal from the charge/discharge terminal of the capacitor, and
in the image formation period, the laser control signal generating unit opens the switch to hold the reference signal in the capacitor and applies the adapted correction signal to the reference potential terminal of the capacitor to generate the laser control signal.

5. A laser beam scanning apparatus according to claim 1, wherein
the correction signal generating unit includes:
a storing unit in which correction data for correcting intensity of the laser beam along the main scanning direction is stored; and
a D/A conversion unit that converts the correction data into the correction signal of an analog amount.

6. A laser beam scanning apparatus according to claim 5, wherein the correction data is correction data generated on the basis of a loss in the main scanning direction in a path leading from the laser oscillating unit to the photosensitive member, the loss in the main scanning direction including a transmission loss of the optical lens.

7. A laser beam scanning apparatus according to claim 1, wherein
the predetermined period other than the image formation period is a forcible light emission period of the laser oscillating unit provided for every scanning in the main scanning direction, and
the correction signal is generated in synchronization with a main scanning synchronization pulse generated by detecting a laser beam in the forcible light emission period.

8. An image forming apparatus comprising:
a photosensitive member;
a laser beam scanning unit that scans the photosensitive member with a laser beam in order to form an electrostatic latent image on the photosensitive member;
a developing unit that applies toner development to the photosensitive member on which an electrostatic latent image is formed and generates a developed image; and
a fixing unit that fixes the developed image,
wherein the laser beam scanning unit includes:
a laser oscillating unit that outputs a laser beam;
a laser beam scanning unit that performs scanning in a main scanning direction with a laser beam and irradiates the laser beam on a photosensitive member via an optical lens;
an error signal generating unit that monitors, in a predetermined period other than an image formation period, intensity of a laser beam outputted from the laser oscillating unit and generates an error signal of an error between output intensity of the laser oscillating unit and a predetermined output reference value;
a correction signal generating unit that generates a correction signal for correcting intensity of a laser beam along the main scanning direction such that intensity of the laser beam in the main scanning direction on the photosensitive member is set to be a predetermined constant value;
a correction signal converting unit that converts the correction signal to an adapted correction signal by attenuating the correction signal; and
a laser control signal generating unit that holds, during the image formation period, a reference signal generated on the basis of the error signal and applies the adapted correction signal to the reference signal to generate a laser control signal for determining intensity of a laser beam outputted from the laser oscillating unit.

9. An image forming apparatus according to claim 8, wherein the correction signal converting unit is configured with an attenuator.

10. An image forming apparatus according to claim 8, wherein
the laser control signal generating unit includes a switch and a capacitor,
in the predetermined period other than the image formation period, the laser control signal generating unit generates the reference signal by closing the switch and charging the error signal in and discharging the error signal from the capacitor, and
in the image formation period, the laser control signal generating unit opens the switch to hold the reference signal in the capacitor and applies the adapted correction signal to the capacitor to generate the laser control signal.

11. An image forming apparatus according to claim 8, wherein
the laser control signal generating unit includes:
a switch; and
a capacitor that has a charge/discharge terminal connected to the switch and a reference potential terminal,
in the predetermined period other than the image formation period, the laser control signal generating unit generates the reference signal by closing the switch and charging the error signal in and discharging the error signal from the charge/discharge terminal of the capacitor, and
in the image formation period, the laser control signal generating unit opens the switch to hold the reference signal in the capacitor and applies the adapted correction signal to the reference potential terminal of the capacitor to generate the laser control signal.

12. An image forming apparatus according to claim 8, wherein
the correction signal generating unit includes:
a storing unit in which correction data for correcting intensity of the laser beam along the main scanning direction is stored; and
a D/A conversion unit that converts the correction data into the correction signal of an analog amount.

13. An image forming apparatus according to claim 12, wherein the correction data is correction data generated on the basis of a loss in the main scanning direction in a path leading from the laser oscillating unit to the photosensitive member, the loss in the main scanning direction including a transmission loss of the optical lens.

14. An image forming apparatus according to claim 8, wherein
the predetermined period other than the image formation period is a forcible light emission period of the laser oscillating unit provided for every scanning in the main scanning direction, and
the correction signal is generated in synchronization with a main scanning synchronization pulse generated by detecting a laser beam in the forcible light emission period.

15. A laser beam scanning method, comprising the steps of:
outputting a laser beam from a laser oscillating unit;
scanning in a main scanning direction with a laser beam and irradiating the laser beam on a photosensitive member via an optical lens;
generating an error signal by monitoring, in a predetermined period other than an image formation period, intensity of a laser beam outputted from the laser oscillating unit and generating an error signal of an error between output intensity of the laser oscillating unit and a predetermined output reference value;
generating a correction signal for correcting intensity of a laser beam along the main scanning direction such that intensity of the laser beam in the main scanning direction on the photosensitive member is set to be a predetermined constant value;
converting the correction signal to an adapted correction signal by attenuating the correction signal; and
generating a laser control signal by holding, during the image formation period, a reference signal generated on the basis of the error signal and applying the adapted correction signal to the reference signal to generate a laser control signal for determining intensity of a laser beam outputted from the laser oscillating unit.

16. A laser beam scanning method according to claim 15, wherein
in the step of generating a laser control signal,
in the predetermined period other than the image formation period, the reference signal is generated by closing the switch and charging the error signal in and discharging the error signal from the capacitor, and
in the image formation period, the switch is opened to hold the reference signal in the capacitor and the adapted correction signal is applied to the capacitor to generate the laser control signal.

17. A laser beam scanning method according to claim 15, wherein
in the predetermined period other than the image formation period, the reference signal is generated by closing the switch and charging the error signal in and discharging the error signal from the charge/discharge terminal of the capacitor, and
in the image formation period, the switch is opened to hold the reference signal in the capacitor and the adapted correction signal is applied to the reference potential terminal of the capacitor to generate the laser control signal.

18. A laser beam scanning method according to claim 15, wherein
the step of generating a correction signal includes the steps of:
storing correction data for correcting intensity of the laser beam along the main scanning direction; and
converting the correction data into the correction signal of an analog amount.

19. A laser beam scanning method according to claim 18, wherein the correction data is correction data generated on the basis of a loss in the main scanning direction in a path leading from the laser oscillating unit to the photosensitive member, the loss in the main scanning direction including a transmission loss of the optical lens.

20. A laser beam scanning method according to claim 15, wherein
the predetermined period other than the image formation period is a forcible light emission period of the laser oscillating unit provided for every scanning in the main scanning direction, and
the correction signal is generated in synchronization with a main scanning synchronization pulse generated by detecting a laser beam in the forcible light emission period.
